(19) United States
(12) Patent Application Publication
(10) Pub. No.: US 2021/0263833 A1
(43) Pub. Date: Aug. 26, 2021

(54) Code Generation Platform with Debugger

(71) Applicant: 4Logik LLC, Chicago, IL (US)

(72) Inventors: Joel Adam Reisner, Northbrook, IL (US); Robert Victor Page, Lincolnwood, IL (US)

(21) Appl. No.: 16/796,204

(22) Filed: Feb. 20, 2020

(51) Int. Cl. G06F 11/36; G06F 8/30

(52) U.S. Cl. CPC G06F 11/3624; G06F 8/30

(57) ABSTRACT

Data is received by an omniscient debugger that comprises a plurality of execution traces of a sample data set and a corresponding logic tree. The logic tree includes a hierarchical representation of a plurality of instructions for an application and the execution traces comprise results of the logic tree being applied to the sample data set. Thereafter, a repository is polled to obtain a baseline corresponding to the sample data set. Differences are then identified between each of the execution traces and the baseline. Later, debugging requests are received and information relating to same can be provided based on the identified differences. Related apparatus, systems, techniques and articles are also described.

### TECHNICAL FIELD

The subject matter described herein relates to a platform providing enhanced techniques for generating, deploying, publishing, and debugging code.

### BACKGROUND

Enterprise application development is the development of applications that achieve business outcomes for organizations. While the tools used to do such development have evolved over time, the underlying processes have largely remained the same, with businesspeople creating requirements, technology people turning the requirements into programming language code, and testing people confirming that the software behaves as expected. The large number of actors, documents, and information exchanges, as well as the varying levels of business and technical expertise among the actors, result in a high-friction process with reduces efficiencies. Development errors and missed requirements are common and, if not identified during the testing cycles, result in production outages once the software is released into the production environment. There are attempts at reducing the friction through the use of agile methodologies or other variations of the software development lifecycle. However, the negative impacts still occur, as these do not address the shortcoming of the development process in a fundamental way.

### SUMMARY

In one aspect, data is received (for example by an omniscient debugger) that comprises a plurality of execution traces of a sample data set and a corresponding logic tree. The logic tree includes a hierarchical representation of a plurality of instructions for an application and the execution traces comprise results of the logic tree being applied to the sample data set. Thereafter, a repository is polled to obtain a baseline corresponding to the sample data set. Differences are then identified between each of the execution traces and the baseline. Later, debugging requests are received and information relating to same can be provided based on the identified differences.

The baseline can include a baseline logic tree, a list of executed instructions, all data inputs and outputs, exceptions during execution of the instructions, and captured analytics during execution of the instructions. The identification of differences can include identifying differences between the logic tree, executed instructions, data inputs, data outputs, exceptions and captured analytics between each of the execution traces and the baseline.

The polling can use a unique identifier associated with the sample data set to obtain the baseline.

The identified differences can be cached in memory to allow for more rapid reuse with subsequent debugging requests.

In some variations, the providing of information can include one or more of: (i) bi-directional step-by-step debugging in which a user navigates forwards and backwards through one or more the execution traces in a graphical user interface while changes in states of objects in relation to the instructions of the logic tree are displayed in the graphical user interface; (ii) data lineage debugging in which all points in an execution trace are identified in which a value in a field has changed and in which before and after values are captured; the data lineage debugging can include identifying any branching decisions that affect an output of an execution path; (iii) tracing by identifying specific instructions that were applied to at least a portion of the sample data set to produce an output; (iv) generating a list representing all instructions that were used to process the sample data set providing an indication of coverage of the logic tree by the sample data set, and causing the list to be displayed in a graphical user interface; or (v) automatically identifying one or more possible changes to the logic tree versus the baseline logic tree that have caused a value to be incorrect.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating components of a code generation platform;

FIG. 2 is a diagram illustrating aspects of a business logic constructor;

FIG. 3 is a diagram illustrating aspects of a code generator;

FIG. 4 is a diagram illustrating aspects of a code executor;

FIG. 5 is a first diagram illustrating aspects of an omniscient debugger;

FIG. 6 is a second diagram illustrating aspects of the omniscient debugger;

FIG. 7 is a diagram illustrating a flat execution table per execution trace;

FIG. 8 is a diagram illustrating aspects of a trace preprocessor;

FIG. 9 is a diagram illustrating data lineage structures created by the trace preprocessor;

FIG. 10 is a diagram illustrating how unique values from the flat execution table are used to create the trace table:

FIG. 11 is a diagram illustrating aspects of coverage analysis;

FIG. 12 is a diagram illustrating aspects of automated defect detection; and

FIG. 13 is a diagram illustrating aspects of a computing device for implementing the current subject matter.

Like reference symbols in the various drawings indicate like elements.

### DETAILED DESCRIPTION

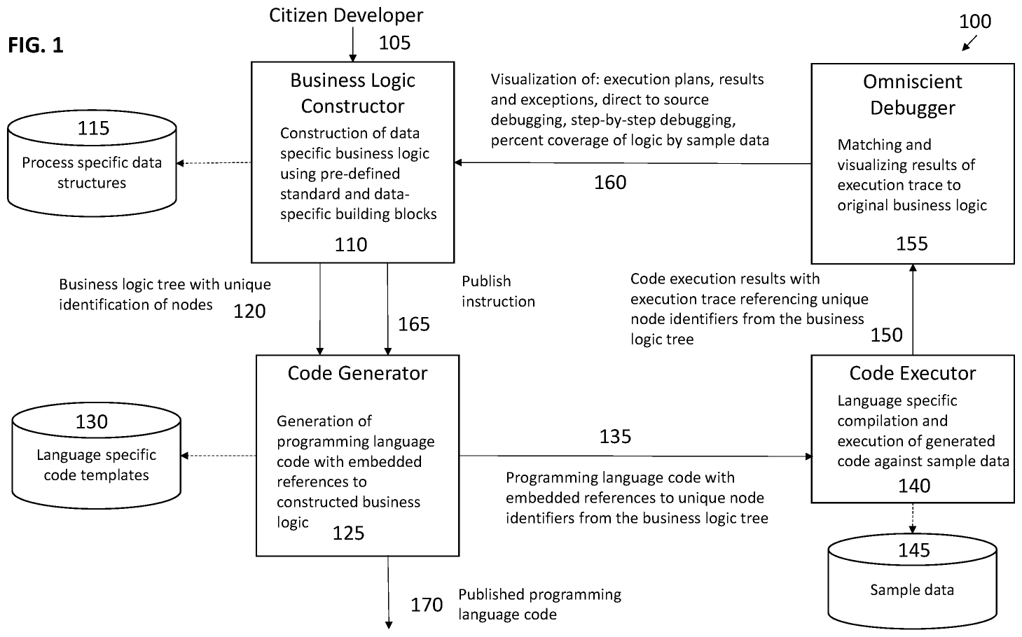

The current subject matter eliminates the inherent inefficiencies of the software development process by allowing citizen developers (i.e., non-technical business users) to produce mission-critical programming language code in data-intensive industries. Data-intensive industries use technology for a subset of the general use-cases that programming languages can address. This subset of use-cases can be addressed more efficiently using a unique platform that tightly-couples four components (as illustrated in diagram 100 of FIG. 1): a business logic constructor 110 for citizen developers, a code generator 125, a code executor 140, and an omniscient debugger 155. The term tight-coupling is used to denote that the design of each component is changed from its general-purpose definition in order to recognize and interact with the other components of the platform to achieve a common outcome: mission-critical programming language code created by a citizen developer.

One particular difficulty addressed herein is debugging which is the process of identifying and removing errors from computer software. As organizations increase their reliance on citizen developers for the development of applications, the debugging capabilities offered to citizen developers by no-code and low-code platforms become key to unlocking efficiencies. Platforms used by citizen developers have limited debugging capabilities which typically only include the tracing of an execution path for a single set of test data, and forward-only step-by-step debugging. In contrast, technology developers generally have richer debugging capabilities provided by their development tools, including tools known as omniscient debuggers 155. The omniscient debuggers 155 provided herein are debuggers that rely on execution traces to enable forward and backward traversal of a program and its states.

In contrast to conventional debuggers, the omniscient debugger 155 is specifically designed for the use of citizen developers 105 in data-intensive industries. Data-intensive industries use technology for a subset of the general use-cases that programming languages can address. Debugging software for this subset of use-cases can be addressed more efficiently using the omniscient debugger 155 which is specifically designed for identifying and resolving data processing related issues. The omniscient debugger 155 can then be integrated with the user-interface of tools used by citizen developers to create applications, in order to provide a rich set of debugging capabilities, matching and even surpassing the debugging capabilities available to technology developers. While the current subject matter describes a larger platform using the omniscient debugger 155, it will be appreciated that the functionality provided by the omniscient debugger 155 is standalone and can be used with other architectures/platforms/systems.

Data-intensive industries are industries that use technology primary for the purpose of transforming data into products and services. Examples of such industries include but are not limited to: Financial Services, Pharmaceutical, Retail, Travel, Health, etc. Firms in these industries focus their technology efforts on sourcing data, processing data and sending data out. The current subject matter provide a unique platform that allows such firms to achieve their desired technology outcomes in a more effective way when compared to the traditional way of developing technology solutions.

At the heart of the platform is a chaining of four main components. First, a business logic constructor 110 that is used by a citizen developer 105 to construct business logic in a visual manner. Second, a code generator 125 that is used to produce programming language code based on the business logic. Third, a code executor 140 that compiles the code, instantiates the code, runs the code against sample data and captures the outputs. Fourth, an omniscient debugger 155 that allows navigation of the execution trace backwards and forwards. Each component's design is changed so that it is linked to the component preceding it in the chain and linked to the component following it in the chain. The fourth component, the omniscient debugger 155, is linked to the business logic constructor 110, thus creating a loop where the outcomes of the business logic are fed back into the visual display used by the citizen developer 105. This loop has the following impacts among other: shortening the development lifecycle considerably, eliminating handover of artifacts between business, technology and testing, empowering citizen developers to generate and debug complex programming language code, etc.

The output of the process is programming language code that is taken by the organization's technology team and embedded in a destination system, whether it be in a cloud, legacy or any other technical environment. The programming language code is visible and is based on code templates that are controlled and optimized by the organization's technology team. The programming language code can then be further optimized by the organization's technology team if required.

FIG. 1 is a diagram 100 illustrating various sequencing and data exchange among a business logic constructor 110, a code generator 125, a code executor 140 and an omniscient debugger 155. In one example, a citizen developer 105 needs to apply business logic to a set of data. In the traditional approach the citizen developer 105, typically a non-developer, would have to write a specification document or an agile story and hand it over to the technology team. Using the current platform, the citizen developer 105 can create and modify business logic, and see the outcomes of the logic, without being exposed to the underlying programming language code.

The business logic constructor 110 comprises a graphical user interface that is used by the citizen developer 105 to construct the business logic, using pre-defined building blocks and operating a pre-defined set of process-specific data structures 115 representing the incoming data and the data exchanged in and out of the business logic in the course of processing the data.

These process-specific data structures 115 can be characterized as a set of data structures defined prior to the citizen developer 105 using the business logic constructor 110. These data structures can include the primary incoming data that the process acts upon, as well as any data structures for data being sent out of the logic and data being returned to the logic.

A business logic tree 120 can have unique identification of nodes such that the output of the business logic constructor 110 is a hierarchical business logic tree 120 containing the series of instructions to be executed on data. Each node of the logic tree can be identified uniquely using a Globally Unique Identifier (GUID). The GUIDs of the nodes can be maintained and carried to the next component, the code generator 125. The business logic tree 120 can also contain references to the pre-defined data structures 115.

The code generator 125 transforms the business logic tree 120 into programming language code. The transformation can be based on pre-defined code templates 130 that represent each of the building blocks used in the logic. The code generator 125, in some variations, is not language specific and can support generating multiple programming languages using different sets of templates 130. What is common to the code produced regardless of programming language, is that the GUIDs that identify each building block in the business logic tree 120 are embedded in the generated programming language code, thus persisting the lineage from the business logic to the code.

Language-specific code templates 130 can be used which comprise one or more sets of programming language templates. Each set can be specific to a programming language or to a flavor of a programming language, for example when the same programming language is used but with different libraries and dependencies. The templates correspond to the building blocks used in the business logic constructor 110 and the business logic tree 120.

Programming language code 135 can include embedded references to unique identifiers from the business logic tree 120; the output of the code generator 125 is programming language code that implements the business logic tree 120. Embedded in the programming language code are the GUIDs from the business logic tree 120.

The code executer 140 compiles the programming language code produced by the code generator 125, instantiates the code into an object, and runs sample data 145 through the newly created object to capture the outcomes. The outcomes collected can be collated based on the GUIDs embedded in the programming language code 135, thus maintaining a lineage from business logic to programming language code to execution outcomes.

The sample data 145 can comprise one or more sets of sample data to be run by the code executor. This can represent among other testing data created by the citizen developer, testing data created by a testing organization, production replay of real-world data, etc. The sample data 145 must match the pre-defined data structure used by the business logic 115.

Code execution results 150 (i.e., the result of executing code by the code executor 140) can include execution trace information referencing unique node identifiers from the business logic tree 120. Stated differently, the output of the code executor 140 can be an execution trace created while processing the sample data 145. This execution trace can be fundamentally different than typical execution traces in that it does not trace individual programming language commands but instead traces higher-level business logic building blocks. A single building block can be expressed as multiple lines in code but to the citizen developer 105 only the outcome of the building block is of relevance.

The omniscient debugger 155 allows the citizen developer 105 to trace the execution of the business logic on the sample data 145. The omniscient debugger 155 in the platform is fundamentally different in design than a typical omniscient debugger 155 in that it is not programming language focused. It is also fundamentally different in that it matches the latest execution trace to a baseline execution trace. Using the embedded business logic building block GUIDs, the omniscient debugger 155 is able to provide a non-technology user with backward, forward and coverage execution information—a function that is normally reserved only to technical developers.

There can be various visualization of outcomes 160 which can be displayed in the graphical user interface of the business logic constructor 110. This closes the loop, allowing the citizen developer 105 to create complex logic and see the outcomes of that logic when transformed into mission-critical programming language code. The loop can be repeated any number of times until the citizen developer 105 is satisfied with the outcomes of the logic.

Once the citizen developer 105 is satisfied with the outcomes, they can instruct the code generator 125 to publish the code 165. The code generator 125 then publishes the programming language code to allow the organization's technology team to take and embed the code in a destination system.

The published programming language code 170 implements the business logic defined by the citizen developer 105 and can be created using optimized mission-critical code templates maintained by the organization's technology team. The programming language code 170 can be read, maintained and further optimized by the technology team if required.

The business logic constructor 110 is an application comprising a graphical user interface configured to let a citizen developer 105 construct business logic specifically for the purpose of sourcing, processing and outputting data. The citizen developer 105 would typically be a non-technical citizen developer 105 such as a business analyst. The logic can be constructed by combining building blocks that represent activities related to the flow of the logic with building blocks that represent manipulation of the data.

The business logic constructor 110 as provided herein provides numerous technical advantages. First, the business logic constructor 110 can be specific to the generation of business logic that manipulates data in data-intensive industries. Second, each building block in the logic can be identified throughout the platform using a Globally Unique Identifier (GUID). This GUID can be maintained throughout the platform and persisted through the code generation by the code generator 125, the code execution by the code executor 140 and debugging by the omniscient debugger 155. Third, the business logic constructor 110 can be tightly coupled with the omniscient debugger 155, which provide rich visualization capabilities to the citizen developer 105; capabilities that are typically reserved to technical developers alone.

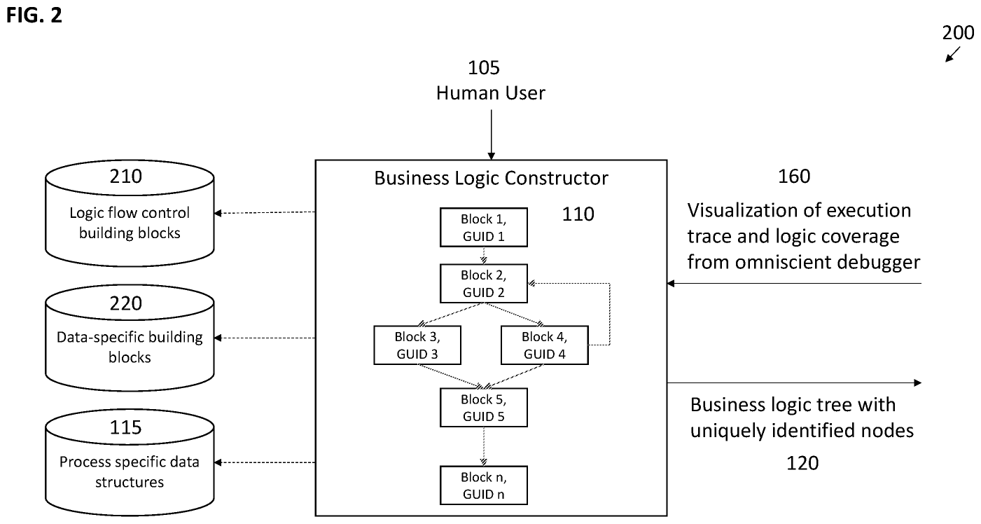

FIG. 2 is a diagram 200 illustrating further aspects of the business logic constructor 110. With this example, a graphical user interface provided by the business logic constructor 110 allows the citizen developer 105 to define business logic to manipulate the data. The business logic can be expressed in the graphical user interface as a flow created using the pre-defined building blocks. The flow can include both general purpose building blocks 210 such as conditional structures, loop structures, etc. which are commonly used to control the flow of logic, in combination with data-specific building blocks 220 that are designed to manipulate the data. Each building block can be identified uniquely using a Globally Unique Identifier (GUID). The GUID identifies the building block and is persisted through the code generation by the code generator 125, the code execution by the code executor 140 and debugging by the omniscient debugger 155.

The logic flow control building blocks 210 can comprise building blocks that represent conditional structures for branching and loop structures for repeating code blocks until a condition is reached. The platform can be extended to include additional logic flow control building blocks as needed.

The data specific building blocks 220 are building blocks that can be specifically designed for the manipulation of data. These data specific building blocks 220 can be extended as additional use-cases are encountered in various data intensive industries.

In addition, the business logic constructor 110 can utilize process specific data structures 115 which can be characterized as the structure of the data being processed by the specific business process that is being defined. The technical formats can be abstracted into business-friendly formats containing fields with business-friendly names. These business-friendly names can be referenced by the building blocks and define the elements of data that the building blocks manipulate.

The business logic constructor 110 can output, as part of the interactions by the citizen developer 105 in the graphical user interface, a business logic tree 120 where each node is uniquely identified using a GUID.

Other information can be displayed in the graphical user interface of the business logic constructor 110 including visualization of execution trace and logic coverage 160 from omniscient debugger 155. Once the business logic constructor 110 outputs the business logic tree 120 with uniquely identified nodes, the platform converts the business logic tree 120 into programming language code. The code is then compiled and run against sample data, which is provided to an omniscient debugger 155, which then links back to the business logic constructor 110. This information provides the citizen developer 105 with immediate feedback as to the outcomes of the logic, exceptions that occurred, the level of coverage by the sample data of the logic and other debugging capabilities usually available to technical developers only.

With reference again to the data-specific building blocks 220, different data-intensive industries and segments within those industries have different needs when it comes to processing data, for example some segments focus on processing transactional data while others focus on processing datasets. These needs can be expressed as a series of data-specific building blocks. Each building block can define a single computer-implemented business action performed on a set of data. The term business action as used herein refers to an abstraction of numerous computing commands that perform one or more related actions. Such an arrangement is technically advantageous because, for a citizen developer 105, what may seem like a single action, for example the copying of a value from a source field to a destination field, can require a significant number of programming language commands to achieve.

The high-level structure of a data-specific building block 220 can include a business friendly name, a well-defined purpose, and a set of attributes supplied by the citizen developer 105 to specify actions that will be taken and the data that the action will be taken on. Actions to be taken can include the assignment of values from various sources, evaluating expressions, sending data requests, processing data responses, filtering data, bucketing data, identifying business exceptions, etc.

The data-specific building blocks 220 can be self-describing and contain all the information required by the business logic constructor 110 in order to render them successfully and to guide the citizen developer 105 as they configure the building blocks. Self-described properties can include one or more of: the ability to contain child building blocks, auto-generated dependent buildings block for complex structure (such as if . . . then . . . else), exception handling options provided by the building block, and the like. Exception handling is a key component of the building blocks as the resulting code is expected to be deployed to a mission-critical environment. Building blocks that have the potential to cause unhandled exceptions contain the ability and sometimes may force the citizen developer 105 to implement exception handling decisions. Such building blocks can contain properties with user-defined expressions, or loop elements where processing decisions must be made should one or more items result in an unhandled technical exception.

TABLE 1
Building blocks specific to data intensive processing

| User | |
|---|---|
| Friendly Name | Purpose |
| Assignment- | Assign a fixed value to a destination field subject to |
| fixed value | type rules |
| Assignment- | Copy a value from a source field to a destination subject |
| from field | to type rules and to properties of the destination and |
| | source fields |
| Assignment- | Assign the result of an expression to a destination field |
| formula | subject to type rules |
| Assignment- | Generate and assign a unique identifier of various types |
| unique | and masks to a destination field |
| identifier | |
| Assignment- | Perform a value-based search in an internal or external |
| List Lookup | table of values |
| Create Message | Create an instance of a pre-defined data format |
| Create Message | Create a repetitive section within a previously created |
| Part | message |
| Send Message | Send a previously created message |
| Mark as | Indicate that a business exception has occurred and |
| Business | decide next action |
| Exception | |
| Create Insight | Records that a business-relevant event has happened |
| Outline | A divider for easier reading of the logic |
| Filter | Iterate through a collection of items and include/exclude |
| | items based on a given criteria |
| Bucket | Iterate through a collection of items and classify them |
| | into a muiti-level multi-criteria hierarchical structure |
| Sort | Sort a collection of items based on a given criteria |

Table 1 presents a non-exhaustive list of data-specific building blocks for the manipulation of data for data-intensive industries. Each building block can have a user-friendly name and a purpose.

The role of the code generator 125 is to transform the business logic tree 120 that is created by the business logic constructor 110 into programming language code. The code generator 125 embeds the unique identifiers of the business logic building blocks (the GUIDs) into the code. The placement of the GUID differs per building block and represents the point in the programming language code at which the building block is considered to have been successfully executed from a business perspective. For example, a building block that evaluates an expression and assigns the result of the expression to a destination field would be expressed as series of programming language commands. First, the expression can be rendered into programming language specific code based on the specific types, operands and built-in functions of the programming language. Second, the code generator 125 can render a series of commands to ensure that the result of the expression can be successfully assigned to the destination field based on the types of result and the field, and based on the properties of the destination field. Finally, the code generator 125 can render the code to assign the result of the expression to the field. It is only after this last action that the business action as a whole can be considered as having been successfully performed. In contrast, a building block specifying an exception that requires the logic to abort processing, might be expressed in certain programming languages using a technical exception and therefore the GUID to indicate that the building block was run successfully must be placed prior to throwing the technical exception.

The code generator 125 is not language specific in that it can generate programming language code in multiple languages (e.g., C#, Java, python, Cobol) and/or language variations (plain Java versus Java referencing specific cloud libraries) for the same business logic tree 120. There is no requirement that the code generator 125 itself be developed in a language that it can produce. The code generator 125 can use one or more sets of code templates. Each set defines the rendering of the building blocks in a specific programming language or a variation, and can include supplemental templates for the required wrappers for individual classes and other language-specific constructs. The requirement of each set of templates can be that it implements the building blocks used by the business logic constructor 110. The code generator 125 itself can be implemented using a visitor pattern where the business logic tree 120 can be scanned and the appropriate templates within the defined template set called to render the code.

The code generator 125 can have an additional unique function whereby when the citizen developer 105 is done constructing the logic, the citizen developer 105 can instruct the code generator 125 to publish the code 170. Publishing the code creates a snapshot, which include the current code, the current business logic tree 120, the details of the citizen developer, a timestamp, and comments about the changes and purposes of publishing the code (which can be entered via the graphical user interface of the business logic constructor 105). The snapshot can be saved to allow the organization's technology team to retrieve the code for deployment in a destination system. The published code 170 may be signed at the time of publishing to ensure that it has not been tampered with manually. The organization's technology department can configure the generator to exclude the GUIDs or to keep the GUIDs in the published code.

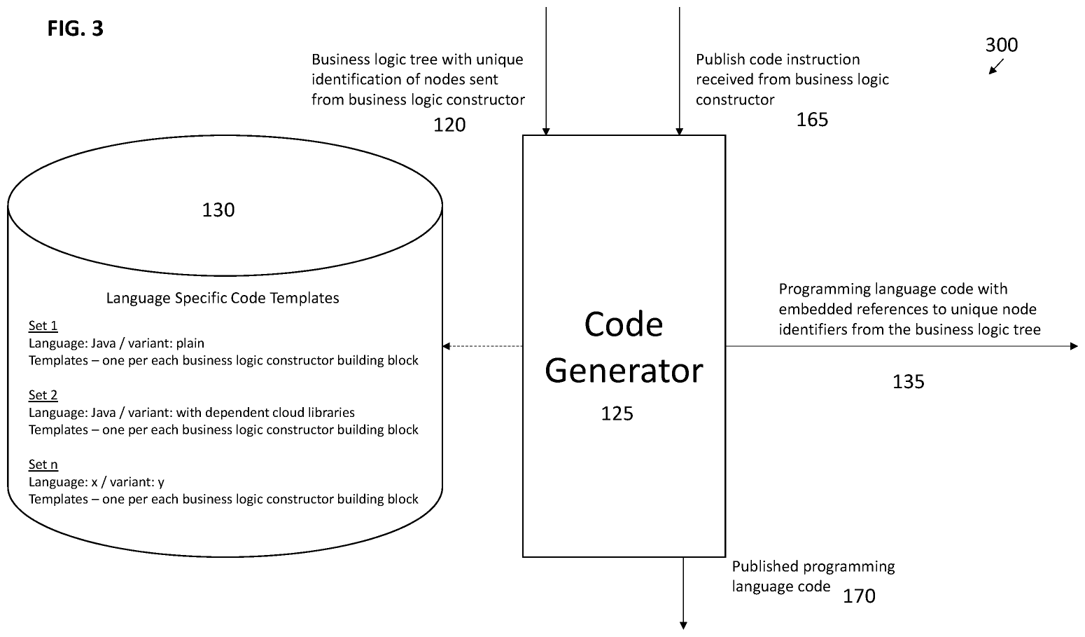

FIG. 3 is a diagram 300 providing a high level architectural view of the code generator 125 The input of the code generator 125 is the business logic tree 120 with uniquely identified nodes which is received from the business logic constructor 110. The business logic tree 120 is a hierarchical tree of building blocks (i.e., nodes, etc.), their configuration and the references to the data fields on which they operate. Each building block can be uniquely identified using a GUID that is carried forward into the programming language code 135.

The code generator 125 takes the business logic tree 120 and converts the business actions encapsulated therein into the programming language code selected for the process using a set of pre-defined templates 130.

The code generator 125 can use a repository of pre-defined code templates (or poll a remote system to obtain templates) to transform the actions specified in the business logic tree 120 into programming language code 135. Each set implements a template for each of the building blocks used in the business logic constructor 110, as well as supplemental templates for the required wrappers for individual classes and other language-specific constructs.

The output of the code generator 125 is programming language code 135 with embedded GUIDs from the building blocks in the business logic tree 120. The programming language code 135 can be sent to the code executor 140 for compilation, instantiation and for execution against sample data.

When the citizen developer 105 is satisfied that the logic produces the expected outcomes, they can cause the code to be published 170. The publish instruction can be received by the code generator 125 (in response to the selection of a graphical user interface element rendered by the business logic constructor 110) which creates a snapshot of the published code 170. The published code 170 is the final output of the process, namely programming language code designed for mission-critical systems and created by a citizen developer 105 in an abstracted interface instead of a technology developer using lower level coding techniques.

The role of the code executor 140 is to compile the programming language code 135 received from the code generator 125, to instantiate the objects, to run one or more sets of sample data through the instantiated objects, to collect the execution information, and to forward it to the omniscient debugger 155. The code executor 140 can collect execution information based on the GUIDs that identify the individual building blocks in the business logic tree 120. This allows the omniscient debugger 155 to later match the outcomes of each block of generated code to the intended purpose defined by the citizen developer 105 using the business logic constructor 110.

The code executor 140 is language specific, so a different instance of the code executor 140 will be required per programming language. Regardless of the programming language being implemented, the inputs and outputs of the code executor 140 can be configured to ensure compatibility with the code generator 125, the previous step in the process, and with the omniscient debugger 155, the following step in the process.

The first steps in the code execution process can comprise compiling the code in-memory and instantiating the objects. Modern programming languages such as JAVA, c#, PYTHON, and the like allow for ad-hoc in-memory compilation and instantiation of code into objects. In the event a programming languages does not support on-the-fly compilation and instantiation, it is possible to mimic the anticipated outcomes using an alternative language that does support ad-hoc compilation and instantiation, and as part of the final publishing of the code re-generate it in the target language. However, the confidence that the code ultimately provides the expected outcome is reduced when compared to code that is generated, executed and published all in the same programming language.

The generated code implements the business logic created by the citizen developer 105 using the business logic constructor 110. Such code is advantageous in that is self-contained and can interact with its environment using a feeder class. The feeder class can connect the business logic to real-world infrastructure resources such as databases, services, file systems, queues, etc. Each business process can have exactly one feeder class. The feeder class is owned by the organization's technology department. All interactions of the logic with the real-world resources can be done via callbacks from the generated code to the feeder class, and can be rendered by the business logic building blocks. Examples of such interactions: retrieve a value from an external list, send a message and wait for a response, send a message and do not wait for a response, generate a unique id, etc. As part of generating the code, the code generator 125 can create an interface class where it places the expected signatures of the methods that the feeder class must implement. Also, for the compilation and instantiation to be successful the organization's technology department may need to provide additional libraries. For example, if the feeder class is required to connect to database, some database-specific libraries and drivers may be required. These are placed ahead of time by the organization's technology department in the repository used by the code executor 140.

Following the compilation and instantiation, the code executor 140 can retrieve one of more sets of sample data from a repository 145, run such data through the instantiated objects and collect the outcomes. Unlike a typical technical execution trace, the outcomes are captured per GUID from the business logic tree 120. The following elements are collected per set of sample data: execution trace by GUID, primary sample data in and out, messages in and out, exceptions and analytics.

The execution trace by GUID can contain a list of all the GUIDs that were executed on the sample data. For example, in branching statements, only the GUID that represents the branch picked for the specific sample data will be marked as executed.

The primary sample data can be the sample data that is injected into the objects, for example an XML, file. That XML, is transformed by the programming language code and ultimately returned to the calling object post-transformation. Both the incoming data and the outgoing data are captured by the code executor 140. In addition to the sample data in and out, the code executor 140 can capture the details of all requests and responses exchanged between the generated code and the feeder class assigned to the process. The code executor 140 can also capture all business exceptions (exceptions defined by the citizen developer) as well as unhandled technical exceptions, that may have occurred while running the sample data through the code executor 140. The code executor 140 can also capture analytics-relevant events that have occurred while running the sample data through the code executor 140. Analytics-relevant events are insights captured as part of the business logic by the citizen developer 105 to record the fact that an interesting event has happened.

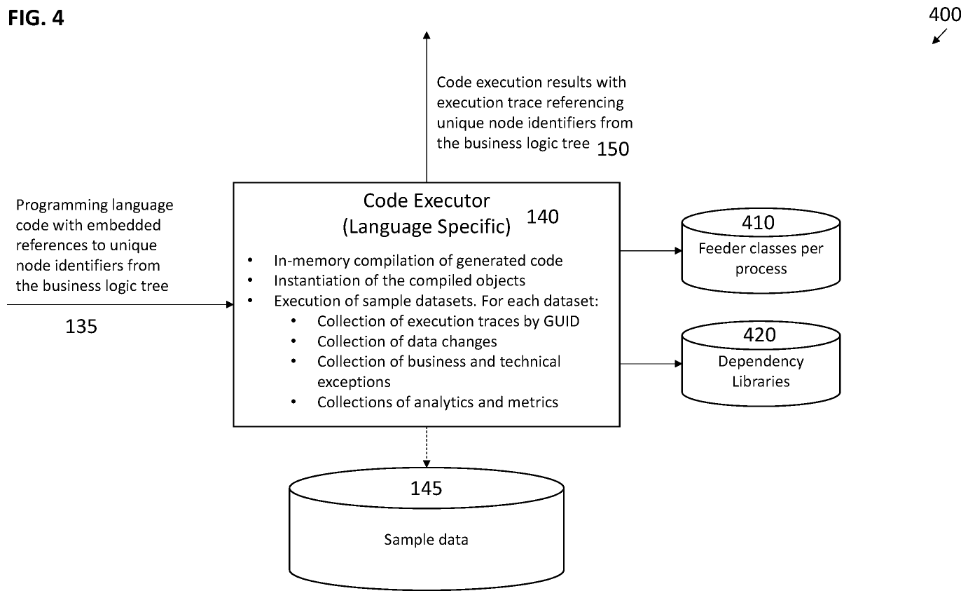

FIG. 4 is a diagram 400 providing a high-level architecture view of the code executor 140. Input into the code executor 140 is the programming language code 135 with embedded references to the GUIDs from the business logic tree 120 (i.e., the output of the code generator 125). The programming language code 135 contains the GUIDs from the business logic tree 120 which allow the code executor to collate the execution results so that they match the individual building blocks of the logic.

There can be a plurality of code executor 140 and/or modules forming part of a single code executor 140 which provide language-specific implementations. The code generator 140 can take the generated programming language code 135, compile it, instantiate it, run sample data 145 through the instantiated objects, collect the results 150 and forward them to the omniscient debugger 155.

As mentioned above, there can be a repository of feeder class 410 per process. In other words, there can be a class per process that connects the business logic implemented in the generated programming language code 135 to real-world infrastructure resources such as databases, services, file systems, queues, etc. These feeder classes, for example, can be owned and maintained by the organization's technology department.

The code executor 140 can also use a repository of dependency libraries 420 that are required to successfully compile and execute the programming language code generated by the code generator 125. It is owned and maintained by the organization's technology department.

A repository of sample data 145 can be provided with one or more sets of sample data per business process. The code executor 140 runs the sample data 145 through the instantiated objects and captures the results.

The code executor 140 collects the code execution results 150 of running the sample data 145 through the instantiated code and sends the data to the omniscient debugger 155. Included in the results can be an execution trace, the primary data in and out, messages exchanged between the executed business logic code and the feeder class, exceptions both business and technical, and any analytics captured as part of the execution.

The omniscient debugger 155 takes the execution traces produced by the code executor, matches them to the expected baseline results predefined for the sample data, and identifies any differences. This is a unique design feature of the omniscient debugger 155 of this platform. Typical omniscient debuggers 155 capture an execution trace but do not match it to a previously captured baseline. Furthermore, the execution trace is not captured in terms of programmatic statements, but in terms of the unique identifiers that were assigned to the building blocks by the business logic constructor 110 at the beginning of the process. This allows the omniscient debugger 155 to operate at a business level instead of a technical level and makes it usable by a citizen developer 105.

All aspects of the execution trace are matched including executed GUIDs, primary data in and out, data exchanges between the generated code and the feeder class, exceptions and analytics. The omniscient debugger 155 then visualizes any difference to the citizen developer 105 inside the business logic constructor 110. It then allows the user to navigate the execution backward and forward in time and see the creation and changes to each object and associated piece of data, each exchange of information with the feeder class, each exception and each analytic.

The omniscient debugger 155 supports direct to source debugging where the citizen developer 105 selects a data field, is shown all the points in the timeline of the execution that the field was modified, and for each point the associated before and after values. Similarly, the omniscient debugger 155 supports the citizen developer 105 selecting a business logic building block, and being shown all the points in the execution timeline that the building block was executed with the related data. Another unique capability of the omniscient debugger 155 is to visually trace the execution of one or more sets of the sample data directly on the business logic. This for example allows the citizen developer 105 to ensure that all building blocks were covered as part of the sample data.

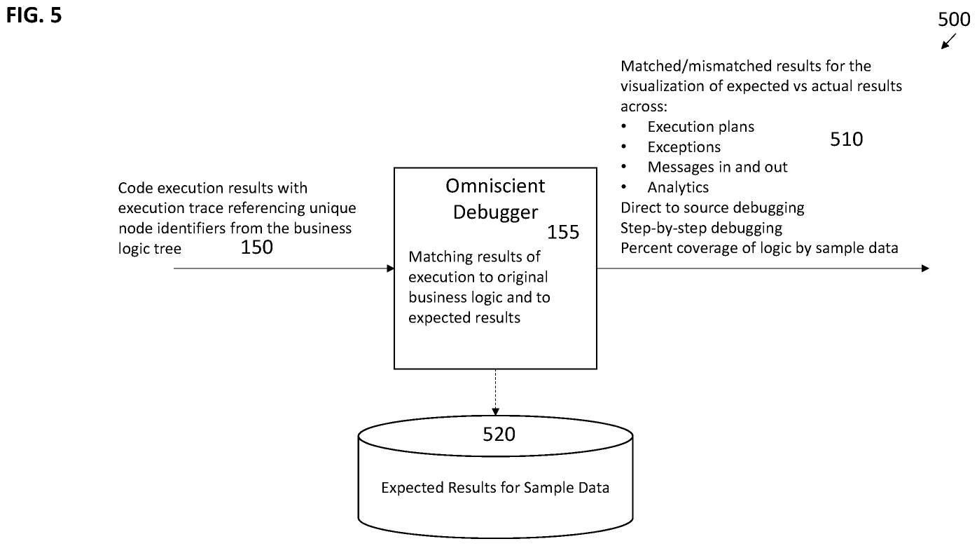

FIG. 5 is a diagram 500 providing a high-level architectural view of the omniscient debugger 155. The code execution results 150 (generated by the code executor 140) are sent to the omniscient debugger 155 and can be collated or otherwise organized by the GUIDs from the business logic tree 120. The omniscient debugger 155 can take the execution results 150, compare them to a baseline 520 that was previously established for the same sample data 145, and then allow the citizen developer 105 to analyze, in a graphical user interface, any differences between the code execution results 150 and the baseline. The graphical user interface can allow for backward and forward navigation in time or directly to a specific data field related event or to a specific building block related event. The information 510 conveyed in the graphical user interface can include, for example, matched/mismatched results as compared to expected/actual results. Various metrics can be provided in connection with the execution plans, thrown exceptions, messages, and other analytics. Other information can be provided for debugging purposes such as amount of coverage by the sample data 145 and the like.

There can be a pre-established baseline of expected execution trace and data results for the sample data 520 that can be used by the omniscient debugger 155. The baseline can comprise one or more of: executed GUIDs, primary incoming and outgoing data, data exchanges between the generated code and the feeder class, business and technical exceptions, or captured analytics.

The design of the omniscient debugger 155 described in this document is fundamentally different than the design of typical omniscient debuggers 155 in several ways. First, it maintains and uses baseline execution traces for the same sample data, whereas typical omniscient debugger 155 only operate on the most recent execution trace. This allows the omniscient debugger 155 to offer unique services such as highlighting differences between multiple executions of the same sample data, and data lineage debugging. Second, it operates on traces collected from multiple sets of sample data in a single action, whereas typical omniscient debuggers 155 only operate on a single execution trace obtained from a single set of sample data at a time. This allows the omniscient debugger 155 to offer unique services such as automated defect detection, and coverage analysis of logic. Third, the omniscient debugger 155 operates at the business instruction level instead of the programming code statement level—a higher level of abstraction. This allows the omniscient debugger 155 to be useful to citizen developers and provide unique services such as tracing at the business instruction level.

The omniscient debugger 155 is initialized by sending it a set of execution traces along with the logic tree that was used to produce the traces. The logic tree is the hierarchical representation of the series of instructions created by the citizen developer 105 in their tool of choice. The execution traces are the results of applying the logic tree to one or more sets of sample data. Each execution trace contains the input sample data, the list of state changes to the input data based on the instructions in the logic tree, and the output data. The sample data that the execution trace pertains to is identified by a unique identifier that allows the omniscient debugger 155 to match it to previous baselines established for the same sample data.

Upon receiving the execution traces and the logic tree, the omniscient debugger 155 preprocesses the data in preparation for responding to debugging requests from the user interface of the tool used by the citizen developer. The omniscient debugger 155 performs a lookup in a repository of pre-established baselines. A pre-established baseline for a set of sample data is an execution trace and an accompanying logic tree that the citizen developer 105 has explicitly identified as producing the correct outputs for the sample data. If a matching baseline is found for a set of sample data, the omniscient debugger 155 loads and matches the latest execution trace to the baseline execution trace and any differences are identified. If a matching baseline is not found for a set of sample data, the omniscient debugger 155 proceeds with the current information only, matching the latest execution trace and logic tree. The output of the preprocessing is typically cached in memory for improved performance. Any service requests received from the user interface while this preprocessing stage is being executed can be parked until the preprocessing is completed, or alternatively the user interface can wait for a signal to be sent from the omniscient debugger 155 indicating readiness.

Once the preprocessing is complete, the omniscient debugger 155 is now ready to respond to debugging requests from the user interface that is used by the user. There are several types of requests: step-by-step bi-directional debugging, data lineage debugging, tracing and coverage, and automated defect detection.

Step-by-step debugging is the typical activity performed by a general-purpose omniscient debugger 155. It gives the user the ability to navigate the execution trace forwards and backwards while seeing the change in states of the objects. The omniscient debugger 155 defined in this document is unique in that it operates at the business instruction level instead of the programming language instruction level. It is able to do so by having both the logic tree and an execution trace which references the individual business instructions in the logic tree. State changes of objects are captured in the execution traces in reference to the business instructions, not the programming level instructions.

Data lineage debugging is a unique feature of the omniscient debugger 155 described in this document and is possible due to the focus on data processing use-cases. The citizen developer 105 selects one of the data outputs of the process. The debugger constructs an execution path for that output, identifying all the points in the execution where the value of the field has changed and capturing before and after values. It also identifies and adds to the execution path any branching decisions that affected the specific output. The execution path is then sent back to the user interface for display. The citizen developer 105 can then navigate the execution path directly instead of navigating the entire execution trace.

Tracing and coverage-analysis are unique features of the omniscient debugger 155 described in this document and are possible due to the focus on data processing use-cases. Tracing is the process of identifying the specific business instructions that were applied to a single set of sample data to produce the output. The omniscient debugger 155 matches the execution trace for the specific sample data to the logic tree and identifies those business instructions that affected the sample data. The list of business instructions that affected the sample data is sent to the user interface for display. Unlike tracing, which focuses on a single set of sample data, coverage analysis is conducted across multiple sets of sample data. Each set of sample data is traced individually to produce a list of the business instructions that affected it. The omniscient debugger 155 then creates a new list that is a union of the individual lists. This list represents all the business instructions that were used to process the multiple sets of sample data, thus giving an indication of the coverage of the logic tree by the sample data that was run through it. This list is then sent to the user interface for display.

Automated defect detection is a unique feature of the omniscient debugger 155 provided herein. It is possible due to the focus on data processing use-cases, the omniscient debugger 155 having predefined baselines for sample data sets, and the omniscient debugger 155 operating on multiple execution traces in a single action. The citizen developer 105 selects one of the data outputs of the process where the output value is incorrect. The omniscient debugger 155 then identifies one or more possible changes to the logic tree versus the baseline logic tree that have caused the value to be incorrect. The list of possible changes is then sent to the user interface for display.

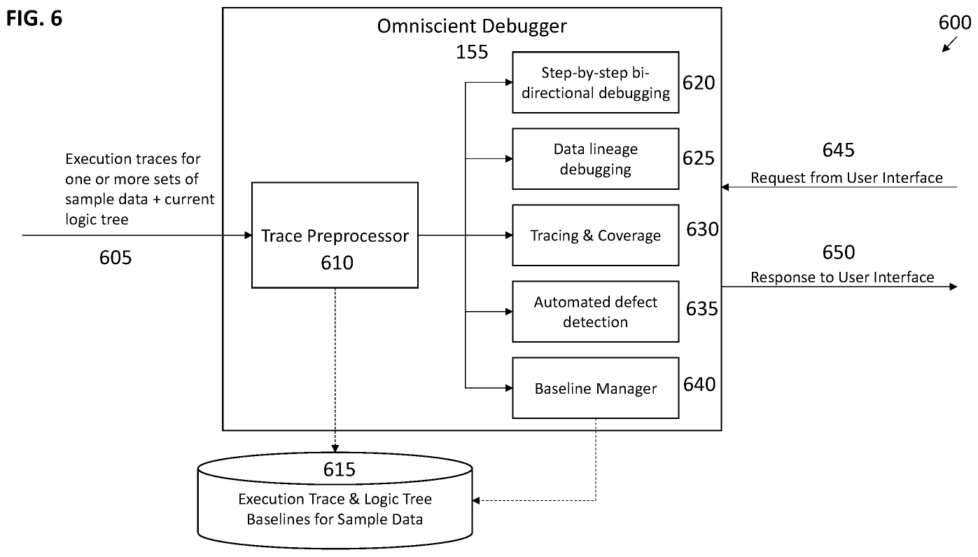

With reference to diagram 600 of FIG. 6, execution traces 605 for one or more sets of sample data and current logic tree are sent to the omniscient debugger 155. Each set of sample data can have a unique identifier. The execution traces reference the business instructions in the logic tree.

A trace preprocessor 610 takes the sample data sets 605 and for each set performs a lookup in a repository 615 containing baseline information for the data sets 615 based on the unique identifiers for the data sets. If a match is found the trace preprocessor 610 matches the baseline and new execution traces to identify differences in the outputs.

Repository 615 contains execution traces and logic tree baselines for sample data sets. Each baseline can comprise an execution trace and a logic tree that were previously identified by the citizen user as producing the right outputs for the sample data.

The omniscient debugger 155 can also provide for step-by-step bi-directional debugging 620 which allows a citizen developer 105 to navigate an execution trace backwards and forwards and to see the change in states of objects. Such functionality can operate at the business instruction level on the logic tree. In particular, the graphical user interface can comprise an element such as bar representing the entirety of the execution from beginning to end so that a user can click on to go to a specific point in the execution trace or drag to move forward and backward in the execution.

Data lineage debugging 625 can be used to construct an execution path for a data output specified by the citizen developer 105, identifying all the points in the execution where the value of the field has changed along with all branching decisions that affected the specific output. The citizen developer 105 can navigate the execution path for the specific data.

Tracing and coverage 630 can be used to trace the execution path of a specific sample data set to identify all the business instructions on the logic tree that affected the sample data. The tracing and coverage 630 can be used to creates a union of the traces across multiple sets of sample data to identify coverage and coverage gaps of the sample data when compared to the logic tree

The omniscient debugger 155 can also provide automated defect detection 635 to allow a citizen developer 105 to select a specific piece of output data that is incorrect, and identify potential changes to the logic tree versus the baseline logic tree that have caused the output to be incorrect using execution traces across multiple data sets.

A baseline manager 640 can be used to manage the baseline saved for a specific set of sample data. When the citizen developer 105 is satisfied that the current logic tree produces the correct outcomes, they send a request 645 to the omniscient debugger 155 to define the latest execution trace and logic tree as the new baseline. The baseline manager 640 can persist the execution trace and logic tree in the repository 615 based on the unique identifier of the data set.

The omniscient debugger 155 can receive request from the user interface 645 (i.e., the tool used by the citizen developer 105) to consume the various services that provided by the omniscient debugger 155. The omniscient debugger 155 can also provide responses to the user interface 650 in connection with said consumed services.

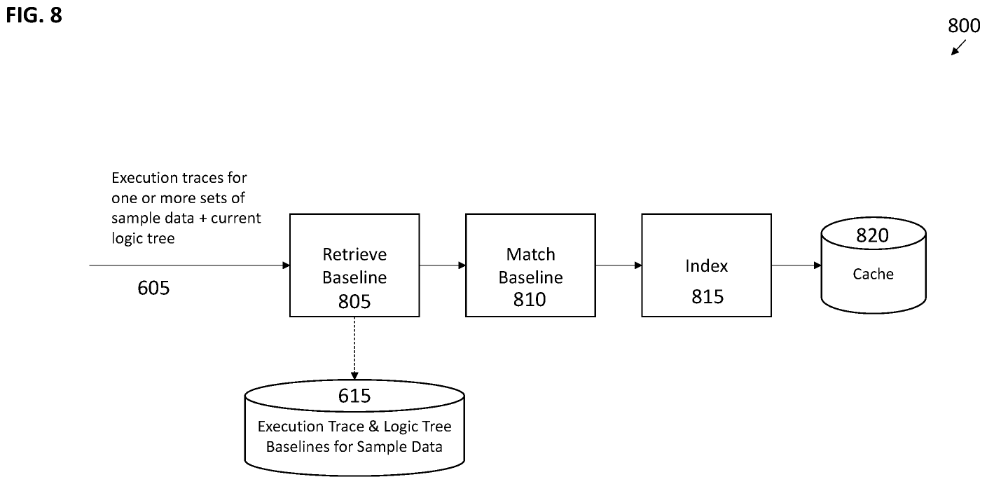

The role of the trace preprocessor 610 is to retrieve any existing baselines for the sample data sets, to match the outputs of the execution traces between the latest execution trace and the baseline execution trace for each sample data set, to index the results, and to cache the indexed results for fast retrieval. FIG. 8 is a diagram 800 illustrating further aspects of the trace processor 610.

Retrieving existing baselines 805 from the repository 615 can be done based on the unique identifier of each sample data set. Only one baseline is allowed per sample data set. A baseline includes the input sample data, the execution trace, the logic tree, and the output data. It is possible for a set of sample data not to have a baseline when the citizen developer 105 has not explicitly set a baseline for the sample data. In such cases the debugging capabilities offered by the omniscient debugger 155 may be limited until the citizen developer 105 sets the baseline.

Matching a baseline 810 to an execution trace can involve matching the input values and matching the output values. The detailed execution trace listing state changes by logic tree instruction is not matched as the assumption is that the citizen developer 105 is changing the logic while expecting the output to remain unchanged. The matching 810 can be based on the unique identifier of each data element. A mismatch in input values indicates a change in the sample data. In such cases the baseline can be marked as invalid and debugging capabilities offered by the omniscient debugger 155 may be limited until the citizen developer 105 sets a new baseline. A change in output values could be the desired outcome of the developer. The mismatch can be logged and provided to the user interface as part of the debugging capabilities of the omniscient debugger 155.

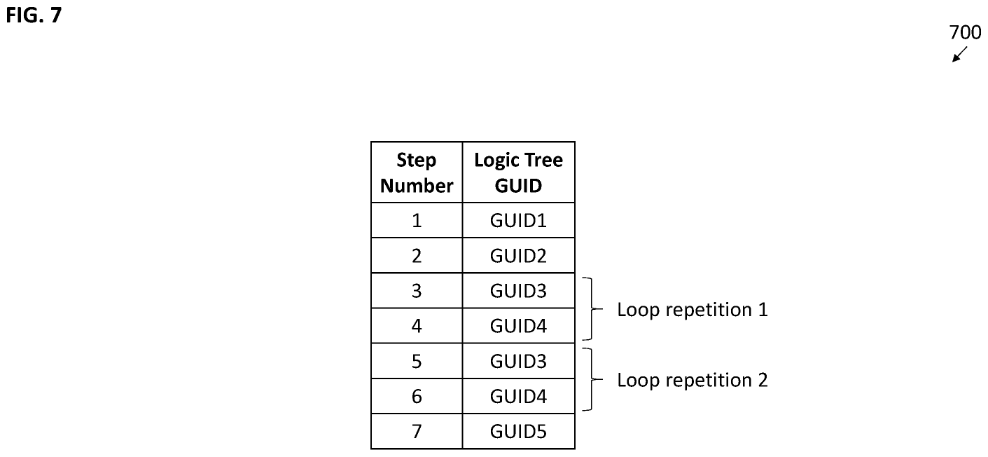

Indexing 815 can be used to create data structures that enable fast access and retrieval of debugging data. The indexing process can start with the creation of a flat execution table for the execution trace. The execution table can comprise a simple auto-incremented number and the related Globally Unique Identifier (GUID) of the business instruction in the logic tree. This creates a sequence similar to a timeline for the execution trace. It is possible to further index this table for rapid access by step number as provided in diagram 700 of FIG. 7 which illustrates a flat execution table per execution trace.

The trace preprocessor 610 can then create an index per data element that captures the input data at initiation and every state change of the data element. For every state change the following are captured: before data, after data and the step number from the execution table that caused the state change. This approach can create a fast access structure that supports forwards, backwards and per location navigation of the execution trace across the data elements available in the system. The results of the indexing can be placed in a memory cache 820 for fast access.

Step-by-step debugging is the typical activity performed by a general-purpose debugger. The omniscient debugger 155 provided herein is unique in that it operates at the business instruction level instead of the programming language instruction level. It is able to do so by having both the logic tree and an execution trace which references the individual business instructions in the logic tree.

The omniscient debugger 155 can supports the following types of requests from the user interface:

Move to start in which the omniscient debugger 155 retrieves the values of the data elements that correspond to the first entry in the flat execution table. The omniscient debugger 155 then sends a response to the user interface that includes the state of the data elements and the number of the step from the flat execution table

Move to end in which the omniscient debugger 155 retrieves the values of the data elements that correspond to the last entry in the flat execution table. The omniscient debugger 155 then sends a response to the user interface that includes the state of the data elements and the number of the step from the flat execution table

Move to step in which the user interface provides a specific step number to the omniscient debugger 155. The omniscient debugger 155 retrieves the values of the data elements that correspond to the specified step in the flat execution table. The omniscient debugger 155 then sends a response to the user interface that includes the state of the data elements and the number of the step from the flat execution table

Move to first GUID is an operation to move to the next instance of a specific business instruction, optionally with a start step number provided by the user interface. The omniscient debugger 155 scans the flat execution table until the business instruction GUID is encountered. The omniscient debugger 155 retrieves the values of the data elements at that point. The omniscient debugger 155 then sends a response to the user interface that includes the state of the data elements and the number of the step from the flat execution table.

Data lineage debugging 625 is an additional technical advantage of the omniscient debugger 155. The citizen developer 105 can select one of the data outputs of the process and request the omniscient debugger 155 to trace its lineage along the execution trace. The omniscient debugger 155 can construct an execution path specific for that output, identifying all the points in the execution where the value of the field has changed and capturing before and after values. The data lineage debugging 625 can rely on the indexes per-data-element results created by the trace preprocessor 610. All changes to a data object have been captured in a data structure and can be navigated forward and backward.

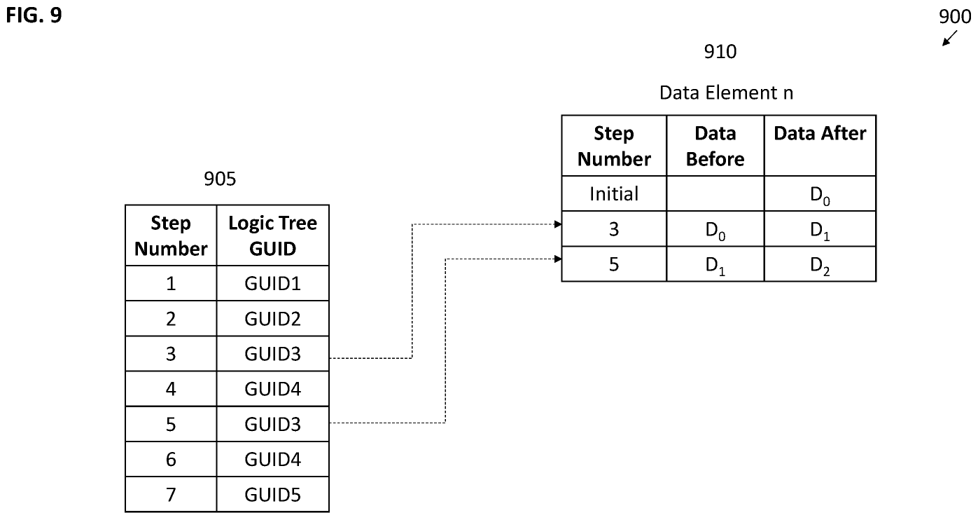

FIG. 9 is a diagram 900 illustrating data lineage structures created by the trace preprocessor 610. A sample flat execution table 905 is illustrated which was created as part of the trace preprocessing. A state change table 910 can created for each input and output data element as part of the trace preprocessing. The data lineage is already captured and can be navigated. Each change can be linked to the step in the flat execution table 905.

The omniscient debugger 155 can support the following types of requests from the user interface for data lineage debugging 625:

Get data element execution path, in which the user interface specifies the data element. The omniscient debugger 155 retrieves the indexed table for the specified data element and returns it to the user interface.

Get data elements by logic tree GUID, in which the user interface specifies a GUID from the logic tree. The omniscient debugger 155 scans the flat execution table. For every instance where the GUI is executed it identifies the related data elements, retrieves their state change table and returns the result set to the user interface. This type of request is used when the citizen developer 105 needs to identify all data elements affected by a specific business instruction on the logic tree. A specific business instruction can affect multiple data elements when used as part of a loop structure.

As part of tracing and coverage 630, tracing is the identification of those business instructions that have been run for a specific sample data set. The operation relies on the flat execution table created by the trace preprocessor 610. The flat execution table includes all GUIDs from the logic tree that have been executed, but it could have duplicate values in the case of loops, which need to be removed.

A trace request from the user interface would specify one and only one sample data set to trace. Upon receiving the trace request, the omniscient debugger 155 can take the flat execution table for the sample data set, de-duplicate it, and create a table containing the unique GUIDs that is then returned to the user interface.

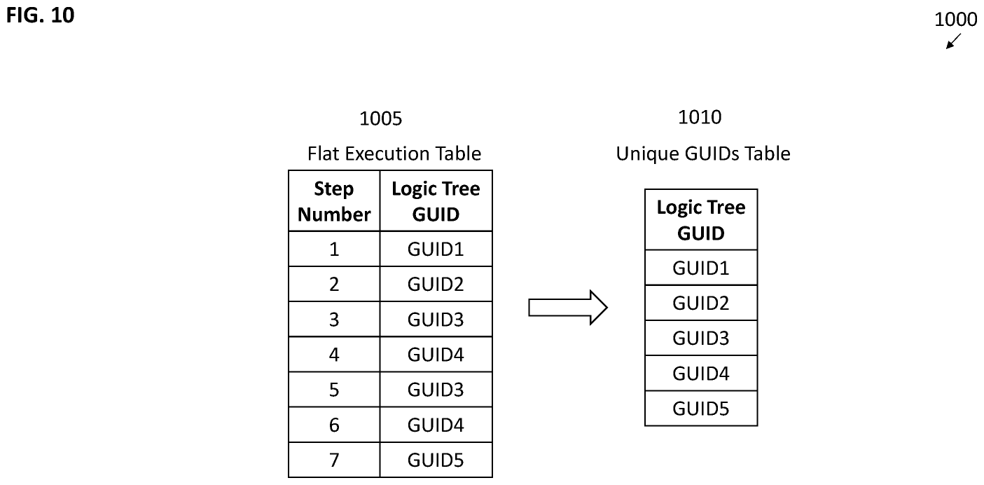

FIG. 10 is a diagram 1000 illustrating an arrangement in which unique values from the flat execution table are used to create the trace table. A flat execution table 1005 that was created by the trace preprocessor 610 is provided which may contain duplicate business instruction GUIDs from the logic tree. A new table 1010 can be created with only the unique values from the flat execution table 1005 (i.e., duplicate entries can be removed).

Coverage analysis as part of the tracing and coverage 630 is the process of tracing multiple sets of sample data, and creating a union of the traces. When matched against the logic tree, coverage information can provide an indication of which business instructions on the logic tree have been run and which have not. This gives valuable information to the citizen developer 105 and is in contrast to conventional techniques which only focus on one execution trace at a time.

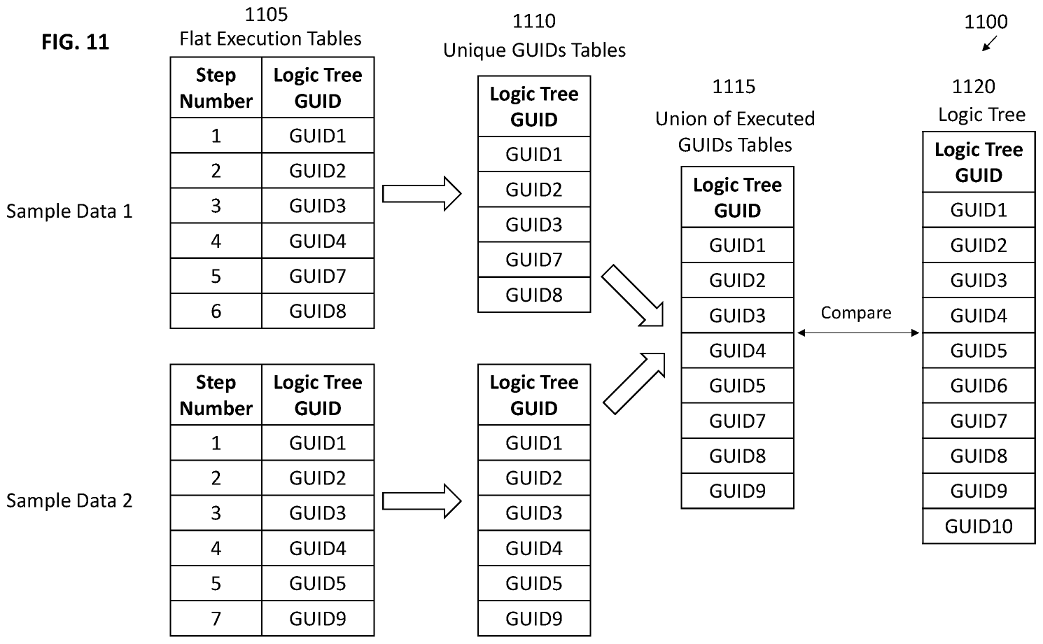

FIG. 11 is a diagram 1100 illustrating aspects of coverage analysis. The input into the process are one or more flat execution tables 1105, one for each sample data set selected by the citizen developer 105 for the coverage analysis. For each flat execution table 1105 the omniscient debugger 155 then creates a de-duplicated table 1110 with unique GUID values. The tables of unique values 1110 can be merged into a single de-duplicated table 1115 of unique values. The table of unique values 1115 is compared against the logic tree as a whole 1120 to identify the business instructions that have been executed, namely GUIDs 1-5 and 7-9 in the diagram 1100, and those business instructions that have not been executed, namely GUIDs 6 and 10 in the diagram 1100.

Automated defect detection 635 provides the ability to predict which change to the logic tree resulted in an incorrect output value. The omniscient debugger 155 is advantageous in that it maintains a baseline execution trace and logic tree for each sample data. By comparing the logic trees and comparing the before and after values in the execution trace, the omniscient debugger 155 can identify to the citizen developer 105 the point in the logic where the data values diverge from the expected baseline. Another unique feature of this omniscient debugger 155 is that it can operate on multiple sample data sets in a single action. When using automated defect detection, the citizen developer 105 can specify that a certain output was incorrect across multiple sets of sample data. This arrangement increases the accuracy of the comparison and of the detection of the likely source of the defect.

The request from the user interface 645 to the omniscient debugger 155 can contain one or more sample data sets, and a specific output data element that the citizen developer 105 has identified as incorrect. The omniscient debugger 155 can compare the baseline state change table to the latest execution state change table created by the trace preprocessor 610 for that data element. The comparison can start at the first element in the table and is a forward scan. Once it identifies a difference versus the baseline, every following command has the potential of being the cause of the defect. The omniscient debugger 155 cannot assume that only the first command encountered is the source of the defect because the expected value could be a result of chaining multiple business instructions on the logic tree. If more than one set of sample data is provided, the omniscient debugger 155 can repeat the process for the additional sample data sets and then overlay the results of the comparison. This configuration is likely to help pinpoint the source of the defect more accurately as different sample data sets take different execution paths along the logic tree. Overlaying the execution paths highlights the business instructions that are common to the same data sets. Exclusion of a business instruction on one or more of the execution paths can be an indication that the source of the defect is not that business instruction.

Once the state change tables have been compared, the omniscient debugger 155 can compares the logic tree. The state change tables point to their respective flat execution trace tables, which in turn point to specific business instructions in the logic tree. The omniscient debugger 155 can compare the business instructions to identify the changes made to the business logic tree 120 versus the baseline. Possible changes are a change in the parameter of an existing business instruction, an introduction of one or more new business instructions, deletion of one or more business instructions, or any combination of the above. The results can be identified and sent back to the user interface as a response message 650.

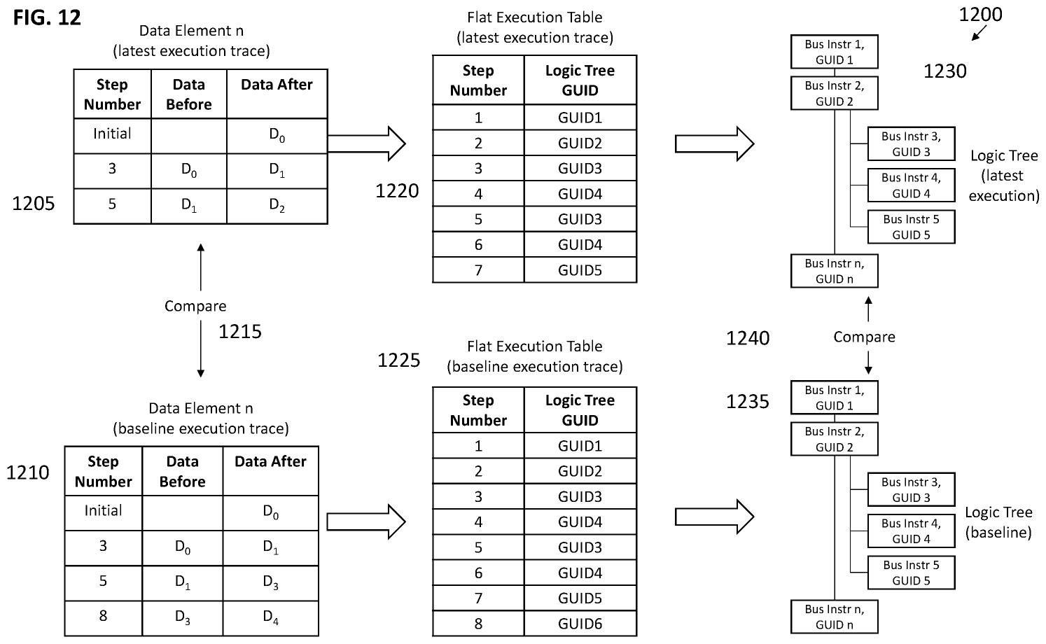

FIG. 12 is a diagram 1200 illustrating aspects of an architecture for automated defect detection. A state change table 1205 can be provided for data element n as created by the trace preprocessor 610 for the latest execution trace. Further, there is a state change table 1210 for data element n as created by the trace preprocessor 610 for the baseline execution trace. These two tables 1205, 1210 can be compared 1215 from the first element in a forward scan. Once a difference is identified, for example at 1225, above, that business instruction and any follow up business instructions become possible sources of the defect. The flat execution table 1220 for the latest execution trace can used to map the step number in the state change table 1205 to the corresponding business instructions in the business logic tree for the latest execution 1230. The flat execution table 1225 for the baseline execution trace can be used to map the step number in the state change table 1210 to the corresponding business instructions in the business logic tree for the baseline execution 1235.

The logic tree for the latest execution 1230 contains the business instructions that produced the latest execution trace and therefore the incorrect output value. The logic tree for the baseline execution 1235 contains the business instructions that produced the baseline execution trace and therefore the correct output value. The two logic trees 1230, 1235 can be compared to identify changes to the business instructions and the source of the incorrect output value(s).

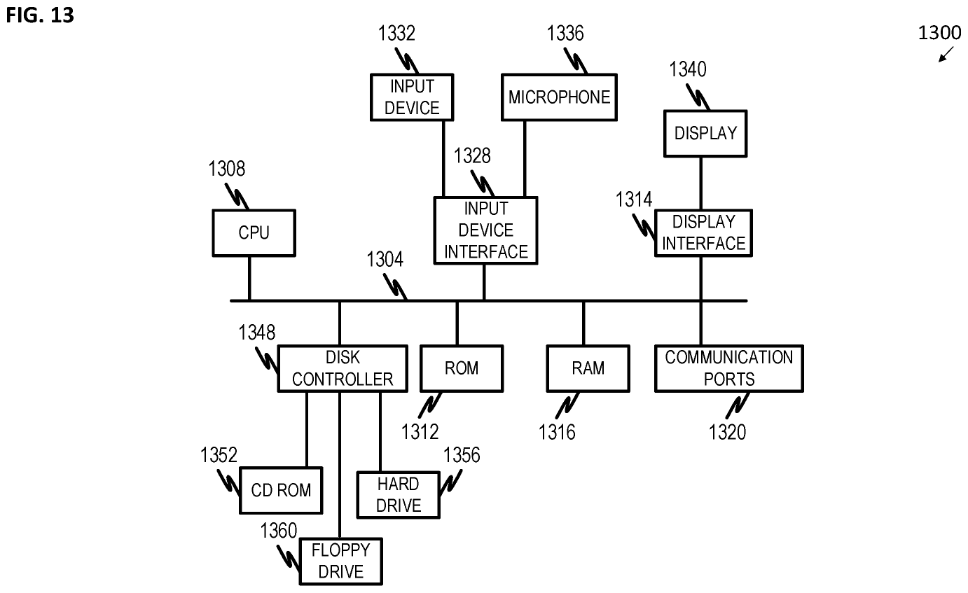

FIG. 13 is a diagram 1300 illustrating a sample computing device architecture for implementing various aspects described herein. A bus 1304 can serve as the information highway interconnecting the other illustrated components of the hardware. A processing system 1308 labeled CPU (central processing unit) (e.g., one or more computer processors/data processors at a given computer or at multiple computers), can perform calculations and logic operations required to execute a program. A non-transitory processor-readable storage medium, such as read only memory (ROM) 1312 and random access memory (RAM) 1316, can be in communication with the processing system 1308 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 1348 can interface with one or more optional disk drives to the system bus 1304. These disk drives can be external or internal floppy disk drives such as 1360, external or internal CD-ROM, CD-R, CD-RW or DVD, or solid state drives such as 1352, or external or internal hard drives 1356. As indicated previously, these various disk drives 1352, 1356, 1360 and disk controllers are optional devices. The system bus 1304 can also include at least one communication port 1320 to allow for communication with external devices either physically connected to the computing system or available externally through a wired or wireless network. In some cases, the at least one communication port 1320 includes or otherwise comprises a network interface.

To provide for interaction with a user, the subject matter described herein can be implemented on a computing device having a display device 1340 (e.g., a CRT (cathode ray tube) or LCD (liquid crystal display) monitor) for displaying information obtained from the bus 1304 via a display interface 1314 to the user and an input device 1332 such as keyboard and/or a pointing device (e.g., a mouse or a trackball) and/or a touchscreen by which the user can provide input to the computer. Other kinds of input devices 1332 can be used to provide for interaction with a user as well; for example, feedback provided to the user can be any form of sensory feedback (e.g., visual feedback, auditory feedback by way of a microphone 636, or tactile feedback); and input from the user can be received in any form, including acoustic, speech, or tactile input. The input device 1332 and the microphone 1336 can be coupled to and convey information via the bus 1304 by way of an input device interface 1328. Other computing devices, such as dedicated servers, can omit one or more of the display 1340 and display interface 1314, the input device 1332, the microphone 1336, and input device interface 1328.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving data comprising a plurality of execution traces of a sample data set and a corresponding logic tree, the logic tree comprising a hierarchical representation of a plurality of instructions for an application, the execution traces comprising results of the logic tree being applied to the sample data set;
polling a repository to obtain a baseline corresponding to the sample data set;
identifying differences between each of the execution traces and the baseline;
receiving a plurality of debugging requests; and
providing information responsive to the debugging requests based on the identified differences.

2. The method of claim 1, wherein the baseline consists of:
a baseline logic tree;
a list of executed instructions;
all data inputs and outputs;
exceptions during execution of the instructions; and
captured analytics during execution of the instructions.

3. The method of claim 2, wherein the identification of differences comprises:
identifying differences between the logic tree, executed instructions, data inputs, data outputs, exceptions and captured analytics between each of the execution traces and the baseline.

4. The method of claim 1, wherein the polling uses a unique identifier associated with the sample data set to obtain the baseline logic tree.

5. The method of claim 1 further comprising:
caching the identified differences in memory.

6. The method of claim 5, wherein the providing information comprises:
bi-directional step-by-step debugging in which a user navigates forwards and backwards through one or more the execution traces in a graphical user interface while changes in states of objects in relation to the instructions of the logic tree are displayed in the graphical user interface.

7. The method of claim 1, wherein the providing information comprises:
data lineage debugging in which all points in an execution trace are identified in which a value in a field has changed and in which before and after values are captured.

8. The method of claim 7, wherein the data lineage debugging further comprises:
identifying any branching decisions that affect an output of an execution path.

9. The method of claim 1, wherein the providing information comprises:
tracing by identifying specific instructions that were applied to at least a portion of the sample data set to produce an output.

10. The method of claim 1, wherein the providing information comprises:
generating a list representing all instructions that were used to process the sample data set providing an indication of coverage of the logic tree by the sample data set; and
causing the list to be displayed in a graphical user interface.

11. The method of claim 1, wherein the providing information comprises:
automatically identifying one or more possible changes to the logic tree versus the baseline logic tree that have caused a value to be incorrect.

12. The method of claim 1, wherein the receiving, polling, identifying, receiving, and providing are performed by an omniscient debugger.

13. A system comprising:
at least one data processor; and
memory storing instructions which, when executed by the at least one data processor, result in operations comprising:
receiving data comprising a plurality of execution traces of a sample data set and a corresponding logic tree, the logic tree comprising a hierarchical representation of a plurality of instructions for an application, the execution traces comprising results of the logic tree being applied to the sample data set;
polling a repository to obtain a baseline logic tree corresponding to the sample data set;
identifying differences between each of the execution traces and the baseline logic tree;
receiving a plurality of debugging requests; and
providing information responsive to the debugging requests based on the identified differences.

14. The system of claim 13, wherein the polling uses a unique identifier associated with the sample data set to obtain the baseline logic tree.

15. The system of claim 13, wherein the operations further comprise:
caching the identified differences in memory.

16. The system of claim 13, wherein the providing information comprises:
bi-directional step-by-step debugging in which a user navigates forwards and backwards through one or more the execution traces in a graphical user interface while changes in states of objects in relation to the instructions of the logic tree are displayed in the graphical user interface;
data lineage debugging in which all points in an execution trace are identified in which a value in a field has changed and in which before and after values are captured,
wherein the data lineage debugging further comprises:
identifying any branching decisions that affect an output of an execution path.

17. The system of claim 13, wherein the providing information comprises:
tracing by identifying specific instructions that were applied to at least a portion of the sample data set to produce an output.

18. The system of claim 13, wherein the providing information comprises:
generating a list representing all instructions that were used to process the sample data set providing an indication of coverage of the logic tree by the sample data set; and
causing the list to be displayed in a graphical user interface.

19. The system of claim 13, wherein the providing information comprises:
automatically identifying one or more possible changes to the logic tree versus the baseline logic tree that have caused a value to be incorrect.

20. A non-transitory computer program product storing instructions which, when executed by at least one computing device, result in operations comprising:
receiving, by an omniscient debugger, data comprising a plurality of execution traces of a sample data set and a corresponding logic tree, the logic tree comprising a hierarchical representation of a plurality of instructions for an application, the execution traces comprising results of the logic tree being applied to the sample data set;
polling, by the omniscient debugger, a repository to obtain a baseline corresponding to the sample data set;
identifying, by the omniscient debugger, differences between each of the execution traces and the baseline;
receiving, by the omniscient debugger, a plurality of debugging requests; and
providing, by the omniscient debugger, information responsive to the debugging requests based on the identified differences.
